(19) United States
(12) Patent Application Publication
(10) Pub. No.: US 2005/0278170 A1
(43) Pub. Date: Dec. 15, 2005

(54) Vocabulary learning device capable of recognizing words based on magnetic force distribution

(76) Inventor: Hong-Tien Lin, Pa-Te City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/866,490

(22) Filed: Jun. 13, 2004

(51) Int. Cl. G10L 21/00

(52) U.S. Cl. 704/227

(57) ABSTRACT

A vocabulary learning device capable of recognizing words has a recognizing device operated in association with letter cards. Each letter card is designated with a letter at one side and mounted with plural magnets at the other side, wherein the magnets are arranged to form a unique pattern different to other letter cards. When the letter cards are placed over the recognizing device, each letter or word is correctly recognized based on the unique magnet arrangements.

### BACKGROUND OF THE INVENTION

1. Field of the Invention

The present invention relates to a vocabulary learning device capable of recognizing words, and more particularly the device is able to correctly self recognize and pronounce an alphabet or a vocabulary based on magnetic force distributions pre-set on alphabet cards.

2. Description of Related Art

The usual way of learning foreign vocabulary is to transcribe related foreign vocabulary from a dictionary on to a notebook for recitation, but this method is generally not very effective. If we can learn foreign vocabulary according to circumstances, or be able to review the words during our free time, it will greatly increase our efficiency for learning foreign vocabulary.

A lot of language studying materials have been commonly used such as books, magazines, multi-media audio/video tapes etc. However, without attractive interaction actions, learners find it difficult to have interest in language studying merely through the use of these passive materials.

### SUMMARY OF THE INVENTION

The objective of the present invention is to provide a vocabulary teaching device capable of accurately recognizing different alphabets/words made up of letter cards and broadcasting correct pronunciation thereof.

To accomplish the objective, the vocabulary teaching device has

a housing having a chamber to receive a circuit board that connects to a speaker mounted in the housing;

a panel mounted on the housing to enclose the circuit board in the housing, wherein multiple inducting recesses are defined on a top surface of the panel to receive a plurality of letter cards;

wherein each letter card has a front side and a rear side, a symbol is designated on the front side and a unique magnetic force encryption is on the rear surface;

whereby after the letter cards are placed in the inducting recesses, the circuit board recognizes the symbol of each card or a vocabulary composed of the letter cards based on the magnetic force encryption of each letter card.

Other objectives, advantages, and unique features of the invention will become more apparent from the following detailed description and accompanying drawings.

### BRIEF DESCRIPTION OF THE DRAWINGS

FIG. 1 is an exploded perspective view of a vocabulary teaching device in accordance with the present invention;

FIG. 2 is a perspective view of the vocabulary teaching device of FIG. 1 in an assembled status;

FIG. 3 is an exploded perspective view of a letter card in accordance with the present invention;

FIGS. 4A-4C are exemplary plan views of different letter cards in accordance with the present invention;

FIG. 5 is a circuit diagram of the vocabulary teaching device of the present invention;

FIG. 6 is an operation view of the vocabulary teaching device of the present invention; and

FIG. 7 is yet another operation view of the vocabulary teaching device of the present invention.

### DETAILED DESCRIPTION OF THE PREFERRED EMBODIMENT

As an example, a vocabulary learning device in accordance with the present invention explained hereinafter is directed to the alphabet. However, it can also be suitable for users who learn any other foreign languages with phonetic symbols or non-alphabetic script.

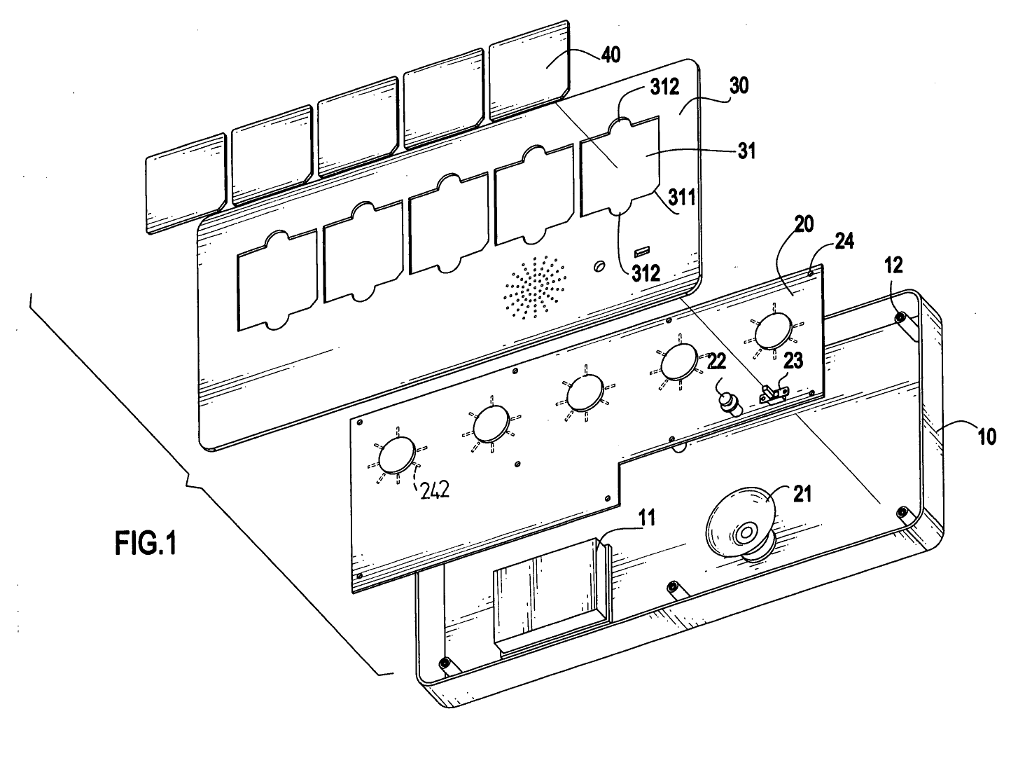

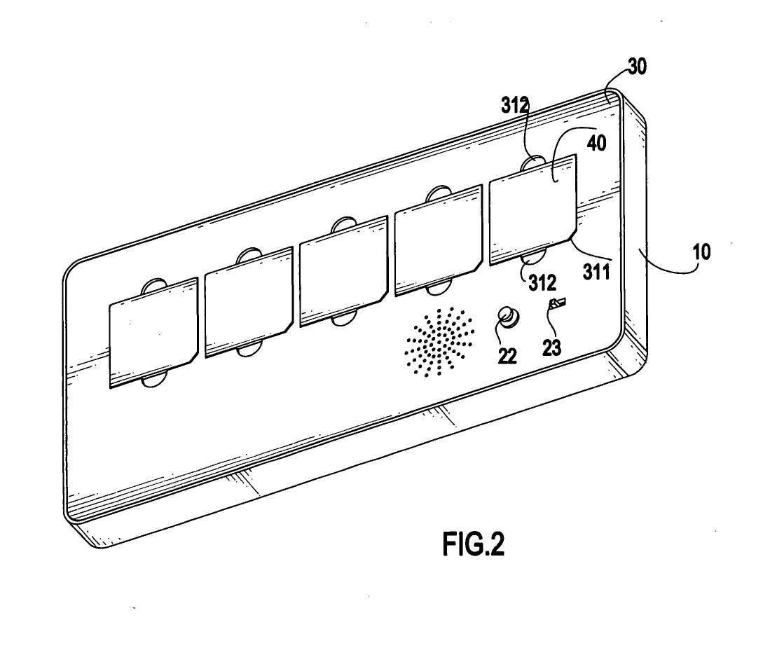

With reference to FIGS. 1 and 2, the vocabulary learning device broadly comprises a housing (10), a circuit board (20), a panel (30) and a plurality of letter cards (40).

The housing (10) defines a rectangular chamber by side walls and a bottom plate. In the chamber, a battery box (11) and a speaker (21) are securely mounted on the bottom plate. A plurality of pillars (12) is uniformly formed at the four corners and around the side walls in the chamber.

The circuit board (20) is securely retained in the housing (10). For example, a plurality of holes (24) is defined at the periphery of the circuit board (20) so that the circuit board (20) is able to be secured to the housing (10) by bolts (22) correspondingly into the pillars (12). In addition to the speaker (21) that connects to the circuit board (20), an audio play button (22) and a letter/word switch (23) are installed on the circuit board (20).

The panel (30) is mounted on the housing (10) to enclose the circuit board (20) and other components in the housing (10). Multiple shallow inducting recesses (31) are defined in the top surface of the panel to receive the letter cards (40).

Each inducting recess (31) forms a bevel edge (311) as a positioning mark so that each letter card (40) can be correctly placed in the inducting recess (31). Two notches (312) are further respectively formed at opposite edges of each inducting recess (31). With the two notches (312), a user can easily poke and pick up the letter card (40) from the inducting recesses (31).

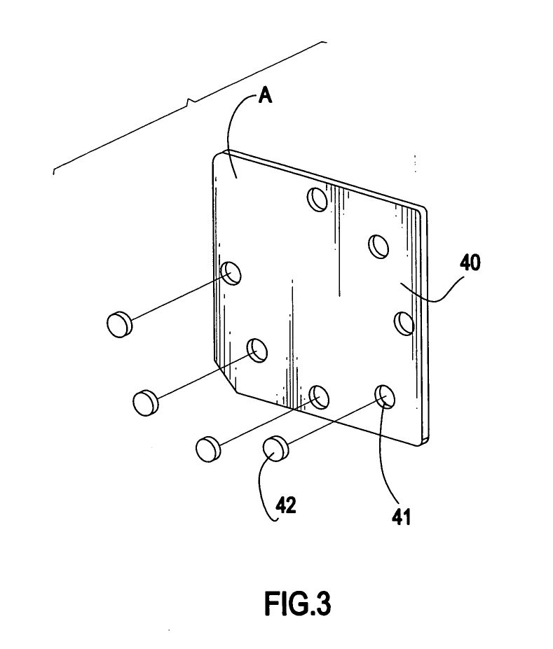

With reference to FIG. 3, each letter card (40) has a front surface and a rear surface, wherein a phonetic symbol or alphabet is designated on the front surface and a plurality of cavities (41) is defined on the rear surface to optionally receive magnets (42). The rear surface of each letter card (40) can be radially divided into eight regions among which only seven regions have the cavities (41) defined therein, wherein the region denoted with A has no magnet placed therein.

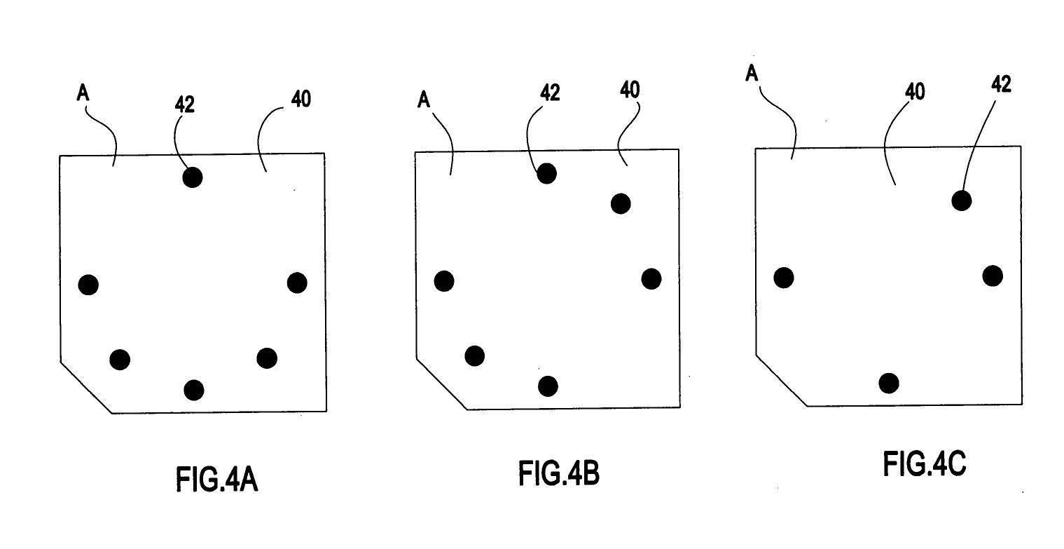

Depending on whether magnets (42) are deposited in the seven cavities (41), there are one hundred and twenty-eight (2⁷=128) combinations of magnet distributions. For the twenty-six letters of the alphabet, each letter is designated with a unique combination. This unique combination is deemed as a magnetic force encryption. Based on the encryption, the alphabet or any word consisting one of more letters can be correctly recognized. With reference to FIGS. 4A to 4C, there are three different combinations representing three particular letters.

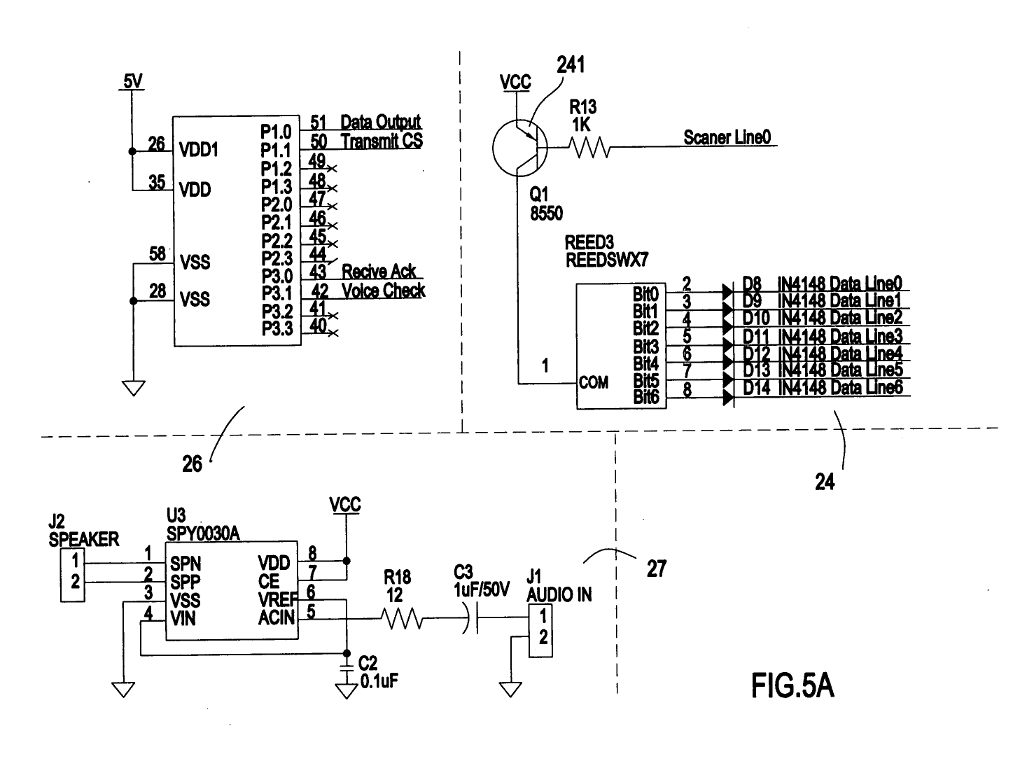

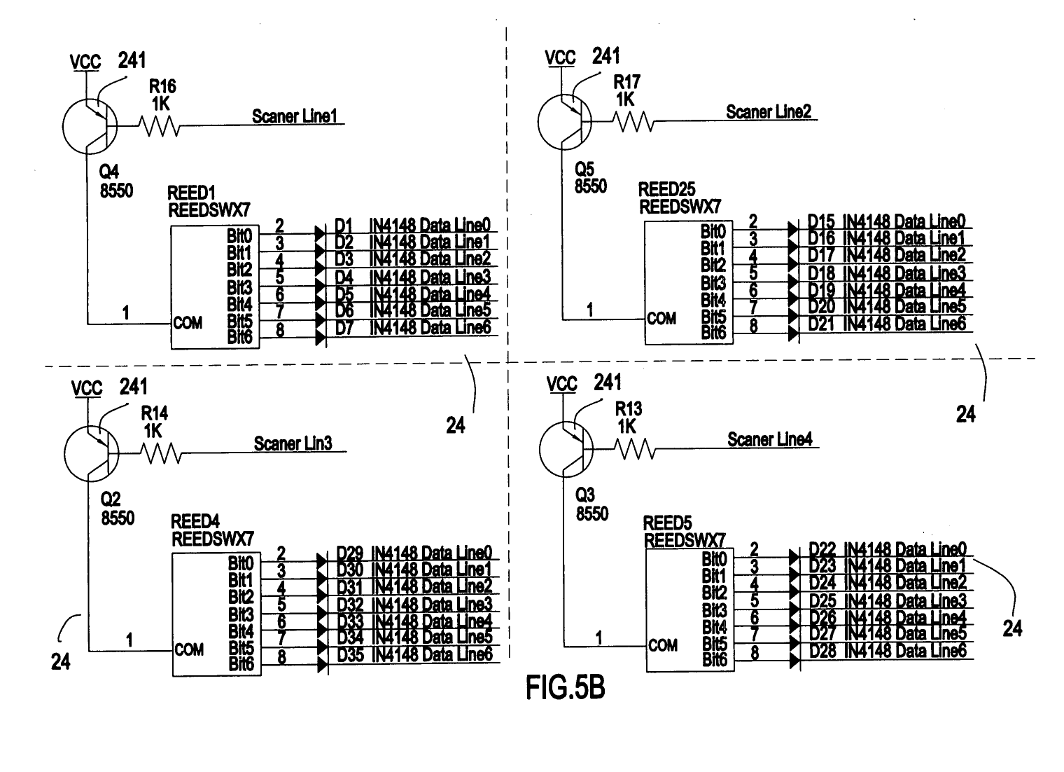

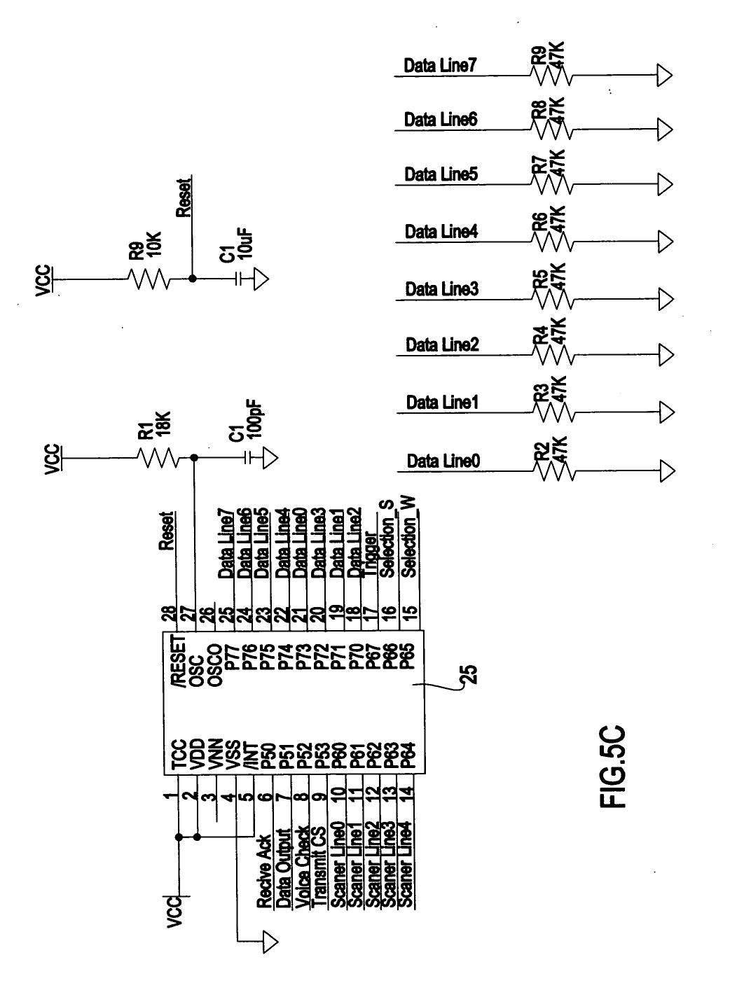

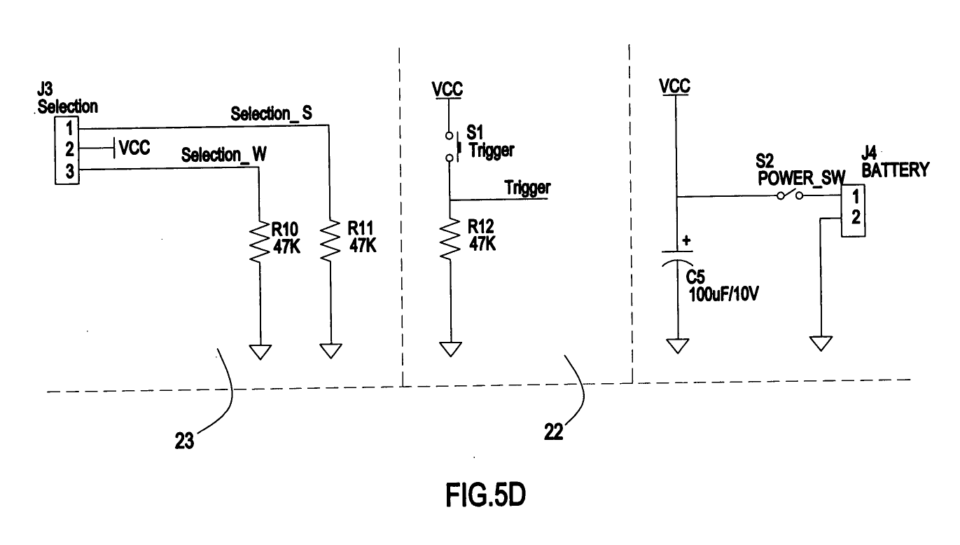

With reference to FIG. 5, the detailed circuit diagram of the circuit board (20) mainly comprises plural inducting units (24), a microprocessor (25), an audio output module (26) and an audio amplifying module (27).

Each inducting unit (24) is corresponded to a respective inducting recess (31) below the panel (30). Each inducting unit (24) includes a transistor (241) with a base terminal connected to a scan line (Scanner_Line0_Scanner_Line4) and a collect terminal connected to seven data lines (Data_Line0_Data_Line6), wherein the distal end of each data line has a reed relay (242, shown in FIG. 2) connected thereto.

The microprocessor (25) provides seven input terminals correspondingly coupled to the data lines of each inducting unit (24). Similarly, each of the five scan lines of the microprocessor (25) is coupled to the scan line (Scanner_Line0-Scanner_Line4) of a respective inducting unit (24). Furthermore, the magnetic force encryption representing each letter and word and the pronunciation information are stored in the microprocessor (25).

The audio output module (26) has input pins Data_Output, Transmit_CS, Recive_Ack and Voice_Check connected to the corresponding pins of the micprocessor (25).

The audio amplifying module (27) is coupled between the audio output module (26) and the speaker (21) to amplify output power of sound signals thus increasing the output volume.

Further, the previously mentioned audio play button (22) is connected to a trigger pin of the microprocessor (25) and the letter/word switch (23) is connected to two input pins (Selection S and Selection W) of the microprocessor (25).

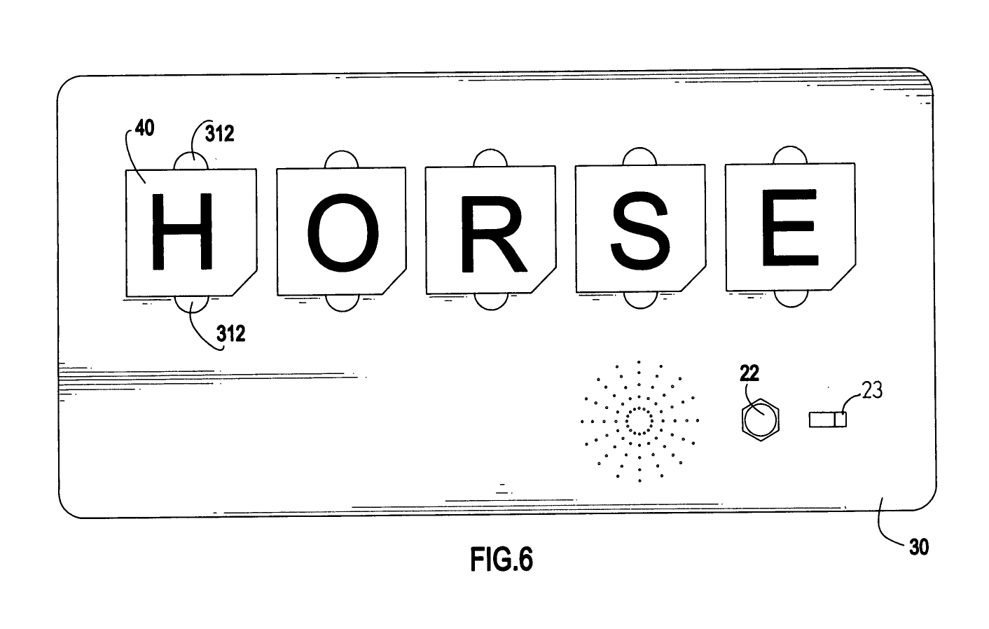

With reference to FIG. 6, when different letter cards (40) forming the word “HORSE” are placed in the inducting recesses (31) with accurate sequence and the letter/word switch (23) is switched to “word” position, the circuit board (20) recognizes the letters H, O, R, S and E based on unique magnetic force encryption of each card (40). Further, when the audio play button (22) is pressed, the audio data representing the pronunciation of the word “HORSE” is output from audio output module (26) and broadcast from the speaker (21). In the case that these letter cards (40) are placed in an inaccurate sequence, the circuit board (20) is unable to successfully identify the word.

With reference to FIG. 5 again, how the circuit board (20) can recognize the letter cards (40) is explained hereinafter. The microprocessor (25) sequentially outputs activating signals to the inducting units (24) thus selecting a corresponding inducting recess (31). For example, once the first inducting recess (31) is selected or enabled, the microprocessor (25) only scans the first inducting recess (31) and the rest of inducting recesses (31) will not be processed. If a letter card (40) is placed in the first inducting recess (31), the magnets (42) mounted on the letter card (40) will induct the corresponding reed relays (242) of the first inducting recess (31).

It is noted that because the seven reed relays (242) of each inducting recess (31) are arranged on the circuit board (20) to correspond to the cavities (41) of each letter card (40), the On/Off status of each reed relay (242) is depended on whether the magnet (42) is retained in the cavity (41). In other words, for a letter card (40) having five magnets (42), only five corresponding reed relays (242) on the circuit board (20) will be changed in status. By collecting the status of each reed relay (242) of each inducting recess (31), the circuit board (20) is able to recognize the arrangement of the magnets (42).

As mentioned above, if only the first inducting recess (31) is selected, the microprocessor (25) only retrieves the magnetic force encryption information of the first inducting recess (31). That is because only the transistor (Q1) (241) of the first inducting unit (24) is activated by the microprocessor (25). Since the transistor Q1 is activated, electricity from the operating voltage Vcc can conduct to each reed relays (242) via data lines. For the reed relay (242) that has been inducted by magnet (42) to become conducted, the microprocessor (25) detects the electricity existing over the data lines. To the contrary, in the case that there is no magnet (42) and the reed relay (242) is not conducted, the microprocessor (25) is unable to detect electricity.

Because the microprocessor (20) does not output activating signals to the rest of the inducting units (24), the transistors (Q2-Q5) are not conducted so that electricity is unable to transmit to these data lines coupled to the transistors (Q2-Q5). Even when the letter cards (40) are placed over the inducting recesses (31), there is no data that the microprocessor (25) can retrieve.

After the first inducting recess (31) has been processed, the microprocessor (25) subsequently outputs the activating signal to the transistor (Q2) of second inducting unit (24) to detect card information of the second inducting recess (31). At the same time, the original conducted transistor (Q1) is deactivated. By continuously repeating the foregoing identifying processes, all information of these inducting recesses (31) is obtained.

The reason that all the inducting recesses (31) must be sequentially scanned one by one it that all the respective reed relays (242) of each inducting recess (31) are coupled in parallel to the microprocessor (25). That is to say the first reed relays (242) of all the inducting recesses (31) are connected together in parallel. Therefore, the card information of a single inducting recess (31) may interfere with other inducting recesses (31) if the microprocessor (25) does not perform sequential scanning.

Based on the collected card information from the inducting recesses (31), the microprocessor (25) controls the audio output module (26) to output corresponding pronunciation data. The audio data is amplified by the audio amplifying module and then broadcast by the speaker (21).

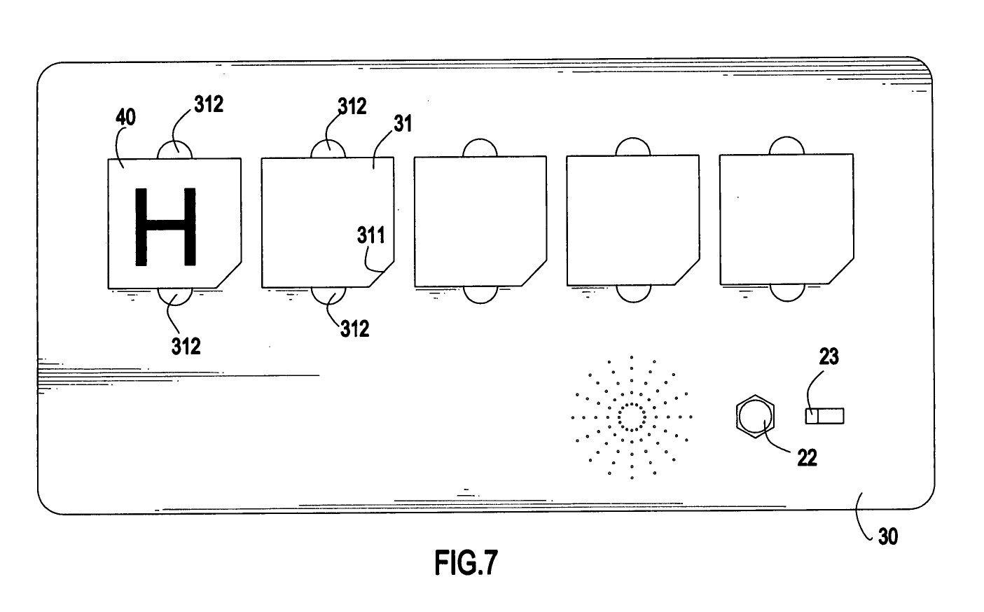

With reference to FIG. 7, if the letter/word switch (23) is changed to the “letter” position, the vocabulary learning device of the invention can recognize a single letter as mentioned above.

It is to be understood, however, that even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A vocabulary learning device comprising:
a housing (10) having a chamber to receive a circuit board (20) that connects to a speaker (21) mounted in the housing (10);
a panel (30) mounted on the housing (10) to enclose the circuit board (20) in the housing (10), wherein multiple inducting recesses (31) are defined in a top surface of the panel to receive a plurality of letter cards (40);
wherein each letter card (40) has a front side and a rear side, a symbol is designated on the front side, and a unique magnetic force encryption is formed on the rear surface;
whereby after the letter cards (40) are placed in the inducting recesses (31), the circuit board (20) recognizes the symbol of each card (40) or a word composed of the letter cards based on the magnetic force encryption of each letter card (40).

2. The vocabulary learning device as claimed in claim 1, wherein the circuit board (20) further comprises:
a plurality of inducting units (24), wherein each inducting unit (24) is corresponded to a respective inducting recess (31) and has a transistor (241) with a base terminal connected to a scan line and a collect terminal connected to plural data lines;
a microprocessor (25) having plural input terminals to which the data lines of each inducting unit (24) are coupled in parallel, and having plural output terminals respectively connected to the scan lines of the respective inducting units (24), wherein the magnetic force encryption and pronunciation data of each symbol are stored in the microprocessor (25);
an audio output module (26) having input pins connected to the microprocessor (25);
an audio amplifying module (27) coupled between the audio output module (26) and the speaker (21) to amplify power of sound signals from the audio output module (26).

3. The vocabulary learning device as claimed in claim 2, wherein the rear surface of each letter includes multiple regions each of which is able to optionally to retain a magnet thus forming the unique magnetic force encryption; wherein each inducting unit (24) has multiple reed relays (242) arranged on the circuit board to correspond to the multiple regions of each letter card (30);
whereby when one of the letter cards (24) is placed over the inducting recess (31), the magnets mounted on the letter card (24) induct respective reed relays (242) to become conducted so as to change voltage levels of the data lines the reed relays (242).

4. The vocabulary learning device as claimed in claim 3, wherein a letter/word switch (23) is mounted on the circuit board and connected to the microprocessor (25).

5. The vocabulary learning device as claimed in claim 4, wherein each inducting recess (31) forms a bevel edge (311) as a positioning mark to allow each letter card (40) to be correctly placed in the inducting recess (31).

6. The vocabulary learning device as claimed in claim 5, wherein two notches (312) are respectively formed at opposite edges of each inducting recess (31) so that the letter card (40) placed in the inducting recess (31) is easily retrievable from the inducting recess (31).

7. The vocabulary learning device as claimed in claim 6, wherein a battery box (11) is mounted on the housing to retain batteries.

8. The vocabulary learning device as claimed in claim 6, wherein the symbol designated on each letter card (40) is an alphabet letter.
